(19) United States
(12) Patent Application Publication
(10) Pub. No.: US 2026/0117755 A1
(43) Pub. Date: Apr. 30, 2026

(54) COMPRESSION RING FOR A PISTON SLIPPER ARRANGEMENT, PISTON SLIPPER ARRANGEMENT, AND AXIAL PISTON MACHINE

(71) Applicant: Danfoss A/S, Nordborg (DK)

(72) Inventors: Stig Kildegaard Andersen, Krusaa (DK); Tommi Kolb, Nordborg (DK)

(21) Appl. No.: 19/363,959

(22) Filed: Oct. 21, 2025

(30) Foreign Application Priority Data
Oct. 29, 2024 (EP) 24209465.4

(51) Int. Cl. F04B 1/124; F03C 1/28

(52) U.S. Cl. CPC F04B 1/124; F03C 1/0605

(57) ABSTRACT

The present invention relates to a compression ring (6) for a piston slipper arrangement (2), wherein the piston slipper arrangement (2) comprises a piston slipper body (3) and a ceramic sliding element (7) and is configured to be provided in an axial piston machine, wherein the compression ring (6) is configured to compress the ceramic sliding element (7). The objective of the present invention is to provide a compression ring (6) which allows an easy assembly of a piston slipper arrangement (2). This objective is solved by a compression ring (6) that comprises first engagement means (8) configured for engaging with corresponding second engagement means (9) of the piston slipper body (3) in order to limit rotation of the compression ring (6) relative to the piston slipper body (3). The invention further relates to a piston slipper arrangement and to an axial piston machine.

### CROSS-REFERENCE TO RELATED APPLICATION

This application claims foreign priority benefits under 35 U.S.C. § 119 from European Patent Application No. 24209465.4, filed Oct. 29, 2024, the content of which is hereby incorporated by reference in its entirety.

### TECHNICAL FIELD

The present invention relates to a compression ring for a piston slipper arrangement, wherein the piston slipper arrangement comprises a piston slipper body and a ceramic sliding element and is configured to be provided in an axial piston machine, wherein the compression ring is configured to compress the ceramic sliding element of the piston slipper arrangement.

Further, the invention relates to a piston slipper arrangement having a piston slipper body, a compression ring, and a ceramic sliding element, wherein the compression ring is configured to compress the ceramic sliding element, wherein the compression ring and the ceramic sliding element form a sliding unit.

### BACKGROUND

Further, the invention relates to an axial piston machine having such a piston slipper arrangement.

An axial piston machine is for example a hydraulic (positive displacement) pump or motor. The axial piston machine comprises pistons, which reciprocate within respective cylinders, wherein the cylinders are provided in a block. The block rotates relative to a swash plate or vice versa, wherein the swash plate and the block are arranged at an angle to each other.

The piston is in contact with the swash plate via a piston slipper arrangement. The piston slipper arrangement is coupled to the swash plate via a ceramic sliding element. Such a ceramic sliding element has a high resistance against pressure but can easily be damaged by pulling forces. Therefore, the ceramic sliding element is compressed via a compression ring.

The compression ring is formed of a metal, in particular a steel, stainless steel, or the like. To assemble the sliding unit, the compression ring is heated such that it expands. When the compression ring is sufficiently heated and thus expanded, it is placed around the ceramic sliding element. When the compression ring cools down and shrinks, it compresses the ceramic sliding element. The ceramic sliding element and the compression ring form together a sliding unit.

The sliding unit is mounted to the piston slipper body. In the state of the art, the sliding unit is attached to the piston slipper body by means of an adhesive.

However, it is difficult to verify that the adhesive bond of the sliding unit to the piston slipper body meets the predefined requirement in a non-destructive manner. Furthermore, it is difficult to orient and fix the sliding unit relative to the piston slipper body in a predefined manner.

### SUMMARY

The problem to be solved is to provide a compression ring which can be easily mounted and oriented onto the piston slipper body.

This problem is solved by a compression ring according to claim 1.

The compression ring is for a piston slipper arrangement, wherein the piston slipper arrangement comprises a piston slipper body and a ceramic sliding element (with second engagement means) and is configured to be provided in an axial piston machine, wherein the compression ring is configured to compress the ceramic sliding element.

The compression ring comprises first engagement means configured for engaging with (the) second engagement means of the piston slipper body in order to limit rotation of the compression ring relative to the piston slipper body.

In particular, the first engagement means may be configured for mechanically engaging with the corresponding second engagement means, e.g. due to a form-fit. Additionally or alternatively, the first engagement means may be configured for magnetically engaging with the corresponding second engagement means.

For example, the first engagement means comprise at least one protruding element. The second engagement means may comprise at least one corresponding recess. The protruding element may protrude axially, radially outwardly, and/or radially inwardly from the compression ring. Protrusions, spline ridges, and/or teeth may be considered protruding elements.

The compression ring may be annular. It might extend about a central axis. An axial direction might be parallel to the central axis (and vice versa). The compression ring may have an inner circumferential surface and an outer circumferential surface. It can have a first end face in the axial direction. The first end face may be configured to face the piston shoe assembly. I can have a second end face in the axial direction. The second end face may be configured to face towards the swash plate of the axial piston machine. If the piston slipper assembly is installed in the axial piston assembly, there might however remain a (small) gap between the second end face of the compression ring and the swash plate.

According to one aspect, the first engagement means can, for example, include one of, several of, or all of the following:
at least one a protrusion (especially several protrusions, e.g. at least three protrusions),
at least one tooth (especially several teeth), e.g. at least one axial tooth and/or at least one radial tooth,
at least one spline element (a spline ridge/a spline groove),
at least one groove, and
the like.

Outer spline elements may mean spline elements arranged at an outer circumferential surface of an element. Inner spline elements may mean spline elements arranged at an inner circumferential surface of an element.

The first engagement means can be (at least partly) provided/formed on a piston-side axial end portion of the compression ring. The piston-side axial end portion is configured for facing the piston slipper body. In particular, the first engagement means can include at least one protrusion (especially at least three protrusions) and/or at least one tooth (especially a plurality of teeth) formed on a piston-side axial end face of the compression ring.

Additionally or alternatively, the first engagement means can (at least partly) provided/formed on an inner circumferential surface of the compression ring, especially in the piston-side axial end portion. For example, the first engagement means can be (at least partly) provided/formed on the inner circumferential surface of the compression ring beyond a part of the inner circumferential surface that is configured to engage the ceramic sliding element, e.g. in at least one region of the inner circumferential surface extending in the axial direction beyond the ceramic sliding element towards the piston slipper body (maybe at the inner circumferential surfaces at protrusions that axially protrude towards the piston slipper body).

Additionally or alternatively, the first engagement means can be formed on an outer circumferential surface of the compression ring, e.g. as at least one outer tooth and/or at least one outer spline element (i.e. a spline ridge/a spline groove). The second engagement means may comprise corresponding features, e.g. at least one inner tooth and/or at least one inner spline element. It is possible that the piston sliding body at least partly covers the outer circumferential surface of the compression ring when the sliding unit is mounted to the piston sliding body. However, this requires a larger size of the piston slider assembly in a radial direction (which is perpendicular to the central axis and/or the axial direction of the compression ring).

In one embodiment, the piston slipper body includes a sleeve for rotationally coupling the compression ring to the rest of the piston body. For example, the first engagement means can be formed at the outer circumferential surface of the compression ring, e.g. as outer teeth and/or spline elements. The second engagement means can be formed at an inner circumferential surface of the sleeve, e.g. as mating inner teeth and/or spline elements. The sleeve can be formed integrally with the rest of the piston slipper body or can be detachable from the rest of the piston slipper body. In the latter case, an outer circumferential surface of the rest of the piston slipper body may include third engagement means (e.g. outer teeth and/or spline elements) for at least rotationally coupling the sleeve to the rest of the piston slipper body. The third engagement means may additionally engage with (a piston-side part) of the second engagement means. For example, teeth and/or spline elements at the inner circumferential surface of the sleeve work both as the second engagement means and for rotationally coupling the sleeve to the third engagement means. Naturally, the sleeve can include separate fourth engagements means for engaging with the third engagement means for at least rotationally coupling the sleeve to the rest of the piston slipper body.

According to one aspect, the first engagement means can be formed in one piece with the compression ring (e.g. in form of the at least one protruding element, for example including at least three protrusions protruding at the first end face). Alternatively the first engagement include at least one separate part fixed to the compression ring, e.g. by form fit, bonding, welding, screwing etc.

The first engagement means are configured to interact (e.g. mechanically, for example by form-fit) with the piston slipper body, e.g. with the second engagement means of the piston slipper body, in order to at least limit rotation of the compression ring relative to the piston slipper body, especially about the central axis.

Especially, the first engagement means are configured to (at least substantially) prevent rotation of the compression ring relative to the piston slipper body, especially with about the central axis.

Thus, the compression ring can be oriented relative to the piston slipper body by means of the first engagement means, especially in combination with the second engagement means (e.g. the recesses). The at least one protruding element (of the first engagement means) and the at least one corresponding recess (of the second engagement means) are designed to form a form-fit and/or a friction fit with each other, for example. The form-fit would be able to hold the ring in a defined (rotational) position when the body moves relative to the plate. This prevents the ring from moving relative to the piston slipper body when the piston slipper arrangement moves relative to the plate. In other words, the at least one protruding element and the at least one recess interact with each other to limit or even prevent a relative rotational movement between the compression ring and the piston slipper body. This results in a low wear and/or longer lifetime, especially of the ceramic sliding element.

According to one aspect, the first engagement comprises at least one protrusion, for example at least three protrusions protruding in the axial direction of the compression ring. For example, the protrusions are evenly distributed. By having at least three protrusions, the compression ring is always positioned correctly in relation to the piston slipper body. Having at least than three protrusions defines the rotational orientation and makes it possible to center the compression ring relative to the piston slipper body. Having more protrusions, the load provided from the ceramic sliding element via the compression ring to the piston slipper body can be distributed more evenly.

In one embodiment, each protrusion comprises at least one contact surface having a normal vector that is parallel to a (local) circumferential direction of the compression ring. In other words, the contact surface is facing in the circumferential direction. This contact face is oriented in a preferred direction of rotation of the piston slipper arrangement relative to the swash plate. This ensures that forces only act in the circumferential direction of the compression ring, so that further compression or decompression of the ring or sliding ceramic element can be avoided.

In one embodiment, the first engagement means are configured to provide a centering functionality for centering the compression ring relative to the piston slipper body with regard to a central axis of the compression ring. The compression ring, especially the first engagement means, can comprise centering means which is configured to center the compression ring relative to the piston slipper body. By centering the compression ring relative to the piston slipper body, the ceramic sliding element is centered accordingly as well. Thus, a load provided form the piston via the piston slipper body and the ceramic sliding element is evenly distributed, such that wear is kept low. The centering means can be the same or different from rotational locking means that limit or even (at least substantially) prevent relative rotation of the compression ring relative to the piston slipper body. For example, the at least three protrusions can constitute both rotational locking means and the centering means of the first engagement means.

In one embodiment, the first engagement means are configured for providing a retaining functionality for (maybe detachably) axially retaining the compression ring relative to the piston slipper body. This allows a simple assembly process, since the sliding unit is fixed to the piston slipper body. Furthermore, it can facilitate maintenance and/or repair of the axial piston machine. As long as the piston slipper arrangement is mounted in the axial piston machine, the piston slipper assembly is secured between the swash plate and the piston rod. However, without the retaining functionality, the sliding unit may be not axially secured relative to the piston during manufacturing, maintenance, and repair whenever the piston does is not in abutment with the swash plate via the piston slipper arrangement. For example, retaining means are formed by a form fit (e.g. a snap-on connection), a force fit, magnetically, or the like. In any case, the retaining means can be the same as and/or different from the rotational locking means. The retaining means can be the same as and/or different from the centering means. If the compression ring (and hence the sliding unit) is axially retained on the piston slipper body in a detachable manner, replacing the sliding unit is easy.

Further, the above problem is solved by a piston slipper arrangement, e.g. according to claim 7.

The piston slipper arrangement has a piston slipper body, a compression ring, and a ceramic sliding element, wherein the compression ring compresses the ceramic sliding element, wherein the compression ring and the ceramic sliding element form a sliding unit.

The compression ring comprises first engagement means. The piston slipper body comprises second engagement means. The first engagement means engage with the second engagement means of the piston slipper body in order to limit rotation of the compression ring relative to the piston slipper body.

The a compression ring may be according to any embodiment described herein.

The first engagement means and the second engagement means can include corresponding structures, especially corresponding geometric structures (mating structures).

The embodiments, modifications, and advantages described with regard to the compression ring and/or the piston slipper body apply accordingly with respect to the piston slipper arrangement, and vice versa.

For example, the at least one protruding element of the compression ring interacts with the at least one recess of the piston slipper body. The at least one recess can be adapted to accommodate the at least one protruding element. This allows an easy assembly of the piston slipper arrangement. Furthermore, the sliding unit can be easily oriented and positioned onto the piston slipper body. Furthermore, the interaction of the first engagement means with the second engagement means limits or even (at least substantially prevents) the rotational movement between the sliding unit and the piston slipper body when the piston slipper arrangement is mounted onto the swash plate. This results in low wear and/or longer lifetime, especially of the ceramic sliding surface.

In one embodiment, the first engagement means comprises at least three protrusions protruding in the axial direction from the compression ring and the second engagement means comprise (at least) a corresponding number of recesses. Having three or more protrusions allows a predefined fit onto the piston slipper body, i.e. it allows the compression ring to be centered relative to the piston slipper body. The protrusions and recesses can be provided uniformly/evenly around the axis of the compression ring. This allows an equal force distribution.

In one embodiment, the ceramic sliding element is annular, and the piston slipper arrangement comprises a radial sealing element which seals the piston slipper body against an inner circumferential surface of the ceramic sliding element. The sealing element prevents pressurized fluid from entering between the sliding unit and the piston slipper body, in particular between an axial face of the ceramic sliding element and a corresponding face of the slipper shoe body. Thus, the piston slipper body and the sliding unit remain in touching connection with each other. As a result, the pressurized fluid needs to take a predetermined path, which allows e.g. a targeted lubrication.

Additionally or alternatively, the piston slipper arrangement comprises an axial sealing element which seals the piston slipper body against an axial end face of the ceramic sliding element. During use, the piston slipper assembly is retained to the swash plate by supporting means. By providing the sealing element, e.g. an O-ring or alike, between the piston slipper body and the axial end face of the ceramic sliding element, axial forces also act on the sealing element so that its sealing effect is reinforced. Whereas at least small (radial) gap might be necessary between the inner circumferential surface of the ceramic sliding ring and an central outer circumferential surface of the piston slipper body facing said inner circumferential surface of the ceramic sliding ring in order to allow mounting the sliding unit onto the piston slipper body, no is no (axial) gap is necessary between the axial end face of the ceramic sliding element facing the piston slipper body and the piston slipper body in the case of high pressure. The ceramic sliding element is pressed into direct axial abutment on the piston slipper body. Hence, the axial sealing element is safely confined in an accommodating recess and cannot be extruded into any adjacent (axial) gap.

In one embodiment, the sliding unit is detachably retained to the piston slipper body. The term “detachably retained” means that a person is able to remove the sliding unit from the piston slipper body, either with tools or without, but without damaging any one of the piston slipper body and the sliding unit. This applies in the same way to assembly. In this way, the sliding unit is retained to the piston slipper body when in use, but it can also be easily replaced.

In one embodiment, the radial sealing element serves as (retaining) means for detachably retaining the sliding unit to the piston slipper body (along the axial direction). The sealing element is for example an O-Ring or alike. Such a sealing element acts on both sides of a gap to be sealed. A force provided by such a sealing element acts via a friction fit and/or via a force-fit. This allows to axially retain the sliding unit to the piston slipper body without further elements. This allows an easy assembly and/or maintenance without the sliding unit falling off the piston slipper unit. It is noted that the engagement between the ceramic sliding element and the piston slipper body via the axial sealing means may be in general not strong enough to prevent relative rotation of the ceramic sliding element relative to the piston slipper body in operation of the axial piston machine.

Additionally or alternatively, the first engagement means and the second engagement means may provide the retaining functionality for detachably axially retaining the compression ring relative to the piston slipper body. The axial retaining functionality may be less strong than the rotational lock functionality in order to allow detaching the sliding unit.

According to one aspect, the first engagement means and the second engagement means can provide the centering functionality for centering the compression ring relative to the piston slipper body with regard to a central axis of the compression ring. The first engagement means and/or the second engagement many may include corresponding centering means for centering the compression ring relative to the piston slipper body. By centering the compression ring relative to the piston slipper body, the ceramic sealing element and respectively the sliding unit is also centered relative to the piston slipper body. Thus, the sliding unit moves uniformly with the piston slipper body, such that the sliding unit, in particular the ceramic sliding element, wears uniformly. This ensures a long lifetime.

In one embodiment, the ceramic sliding element extends in its axial direction beyond the piston slipper body and the compression ring. This ensures that the ceramic sliding element is the only element of the piston slipper assembly which slides on the swash plate. Even if the ceramic sliding element wears, there is still a gap between the swash plate and the compression ring. Thus, a contact between the compression ring and the swash plate is prevented. This results in a long lifetime.

Further, the problem is solved by an axial piston machine having a piston slipper arrangement as described above.

The embodiments, modifications, and advantages disclosed with respect to the compression ring, the piston slipper body, and/or the piston slipper arrangement apply accordingly with respect to the axial piston machine and vice versa.

The axial piston machine pump can be a positive displacement pump. According to one embodiment, the axial piston machine can be of variable displacement type.

### BRIEF DESCRIPTION OF THE DRAWINGS

The invention is described below with reference to a preferred embodiment in conjunction with the drawing. Herein shown:

FIG. 1 A schematic perspective view of a piston slipper arrangement and a piston,

FIG. 2 a schematic cross-sectional view of a first embodiment of a piston slipper arrangement,

FIG. 3 a schematic cross-sectional view of a second embodiment of a piston slipper arrangement, and

FIG. 4 a schematic view of a sliding unit.

### DETAILED DESCRIPTION

Identical elements or similar elements, or elements with the same function are referred to below with the same reference numbers.

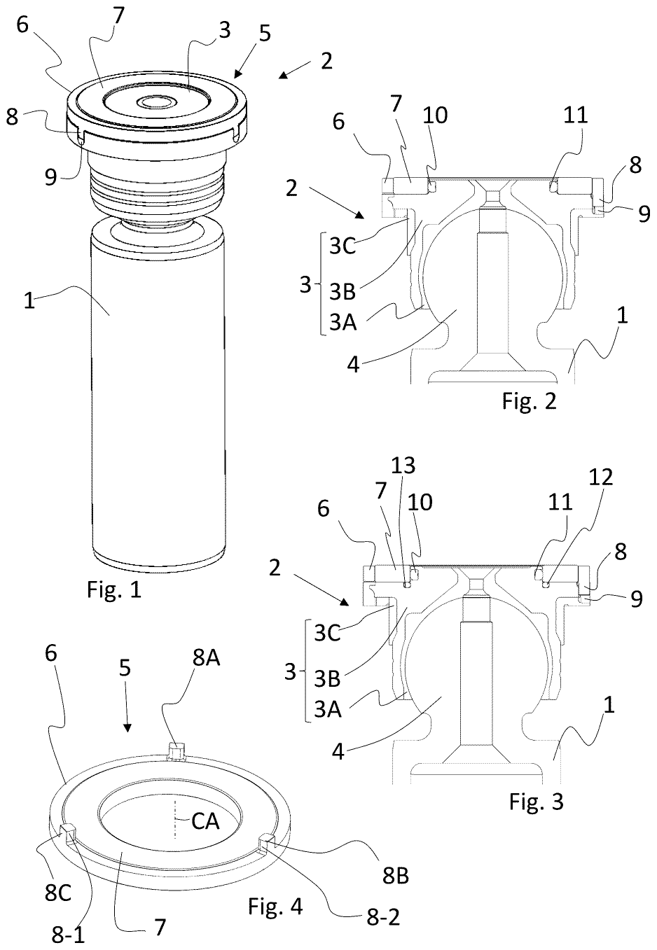

FIG. 1 depicts a schematic view of a piston 1 and a piston slipper arrangement 2 of a not depicted axial piston machine. The piston slipper arrangement 2 comprises a piston slipper body 3, which accommodates a ball-shaped end 4 (not depicted in FIG. 1) of the piston 1. The piston slipper body 3 is formed of an inner piston slipper body 3A interacting (mechanically engaging) with the ball-shaped end 4, a main piston slipper body 3B and an outer piston slipper body 3C. Further, the piston slipper arrangement 2 comprises a sliding unit 5 being formed of a compression ring 6 and a ceramic sliding element 7.

The ceramic sliding element 7 is annular having an inner circumferential surface and an outer circumferential surface. The outer circumferential surface interacts with the compression ring 6. The inner circumferential surface may serve for sealing purposes.

The compression ring 6 compresses the ceramic sliding element 7.

The ceramic sliding element 7 is prevented from rotation relative to the compression ring 6, in more detail from relative rotation about the central axis CA.

There are radial press forces between the compression ring 6 and the ceramic sliding element 7. In more detail, the inner circumferential surface of the compression ring 6 presses against an outer circumferential surface of the ceramic sliding element 7. This press-fit engagement prevents the ceramic sliding element 7 from rotation relative to the compression ring 6. Optionally, there can be further fixation means for preventing relative rotation of the ceramic sliding element 7 with respect to the compression ring 6.

The compression ring 6 comprises first engagement means. In this example, the first engagement means consist of protrusions 8 protruding in an axial direction of the compression ring 6 towards the piston slipper body 3.

The piston slipper body 3 comprises second engagement means. In this example, the second engagement means include recesses 9, which are formed to accommodate the protrusions 8.

The first engagement means of the compression ring 6 (in this example the protrusions 8) engage with the second engagement means (in this example the recesses 9) in order to limit, in more detail to (at least substantially) prevent rotation of the compression ring 6 relative to the piston slipper body 3. In more detail, the interaction of the first engagement means with the second engagement means limits, in more detail (at least substantially) prevents rotation of the compression ring 6 relative to the piston slipper body 3 with respect to the axial direction, especially about a central axis CA (shown in FIG. 4).

As noted above, the ceramic sliding element 7 is prevented from rotation relative to the compression ring 6. In other words, the ceramic sliding element 7 is at least rotationally coupled to the compression ring 6. Actually, due to the high frictional forces between the inner circumferential surface of the compression ring 6 and the outer circumferential surface of the ceramic sliding element 7, the ceramic sliding element 7 may be rotationally and axially fixed to the compression ring 6.

As a consequence, relative rotation of the whole sliding unit 5 (and in particular of the ceramic sliding element 7) with respect to the piston slipper body 3, especially about the central axis CA, is limited, in more detail (at least substantially) prevented due to the interaction of (the engagement of) the first engagement means of the compression ring 6 (in this example the protrusions 8) with the second engagement means (in this example the recesses 9) of the piston slipper body 3.

FIG. 2 depicts a first embodiment of the piston slipper arrangement 2 having the piston slipper body 3 and the sliding unit 5 consisting of the compression ring 6 and the ceramic sliding element 7. Further, the piston slipper arrangement 2 comprises a radial sealing element 10, which seals between the inner circumferential surface of the annular ceramic sliding element 7 and the piston slipper body 3. The radial sealing element 10 is partly provided in a radial sealing element groove 11 of the piston slipper body 3 and interacts with the inner circumferential surface of the ceramic sliding element 7.

FIG. 3 depicts a second embodiment of the piston slipper arrangement 2, which substantially corresponds to the first embodiment. The piston slipper arrangement 2 comprises the piston slipper body 3 having recesses 9, the compression ring 6 having protrusions 8, the ceramic sliding element 7 and the radial sealing element 10.

Compared to the first embodiment, the piston slipper arrangement 2 shown in FIG. 3 additionally comprises an axial sealing element 12 being partly arranged in an axial sealing groove 13 which is formed in the piston slipper body 3.

At high pressures, e.g. during a compression of the piston slipper arrangement 2, the axial sealing element 12 is compressed. Since the axial sealing element 12 is provided within the axial sealing groove 13, the axial sealing element 12 cannot escape this axial sealing groove 13, since the ceramic compression ring 6 is pressed (in the axial direction) against the piston slipper body 3. Thus, the axial sealing element 12 helps to ensure tight sealing.

In both embodiments, the compression ring 6 is annular having its inner circumferential surface and an outer circumferential surface. Further, the compression ring 6 comprises an (axial) end face from which the protrusions 8 protrude. This (axial) end face faces to the piston slipper body 3.

FIG. 4 depicts the sliding unit 5. The sliding unit 5 is formed of the compression ring 6 and the ceramic sliding element 7.

Further, the compression ring 6 defines the central axis CA, see FIG. 4. The central axis CA is defined by the annular form of the compression ring 6 and/or by the annular form of the ceramic sliding element 7.

In this example, the first engagement geometry 8 is formed by the protrusions 8A, 8B, 8C. The second engagement means are formed by the recesses 9.

The second engagement means are configured for interaction with the first engagement means. In this example, the recesses 9 are formed to accommodate the protrusions 8. During operation, both engagement means (i.e. the protrusions 8 and the recesses 9) are mechanically engaged. Each protrusion 8A, 8B, 8C comprises a first and a second contact surface 8-1, 8-2. The first and the second contact surfaces 8-1, 8-2 have a normal vector that is parallel to a (local) circumferential direction of the compression ring 6. The circumferential direction of the compression ring 6 may correspond to a circumferential direction about the central axis CA. Each of the contact surfaces 8-1, 8-2 are configured for mechanically engaging with a corresponding surface of the corresponding protrusion 8. Said corresponding surface (not shown) of the corresponding protrusion 8 may face in the circumferential direction of the corresponding recess 9 for receiving engaging with this protrusion 8. In other words, the corresponding surface of the recesses 9 have a normal vector that is parallel to a (local) circumferential direction about the center axis CA, respectively.

Depending on a relative direction of rotation between the piston slipper body 3 and the sliding unit 5, the engagement of the first engagement means (the protrusions 8) and the second engagement means (the recesses 9) might vary. Depending on the direction of relative rotation, at least one of the first contact surface 8-1 or the second contact surface 8-2 is in contact with a respectively formed surface of the corresponding recess 9. In one modification, either the first contact surface 8-1 or the second contact surface 8-2 is in contact with the corresponding formed surface of the recessed geometry. Alternatively, both contact surfaces 8-1, 8-2 are constantly in contact with the corresponding surface of the recessed geometry, respectively.

The recesses 9 of the second engagement means extend in the axial direction further than the protrusions 8, to allow a defined fixation of both engagement means. In other words, the first engagement means of the compression ring 6 and the second engagement means of the piston slipper body 3 may be formed such that the compression ring 6 can, as a whole, snugly abut onto the piston slipper body 3 in the axial direction.

The recesses 9 can be formed in the outer piston slipper body 3C and the main piston slipper body 3B.

Alternatively, the piston slipper body 3 can be formed of a monolithic material, comprising the recesses 9.

In another alternative, the piston slipper body 3 is formed of further elements, wherein the recesses 9 are formed in one or more elements forming the piston slipper body 3.

The first and the second embodiment each comprise the radial sealing element 10, which provides a sealing function between the inner circumferential surface of the ceramic sliding element 7 and the piston slipper body 3. The radial sealing element 10 is accommodated in the radial sealing groove 11 provided on the piston slipper body 3. The radial sealing element 10 protrudes radially outward (e.g. by a certain amount) from the radial sealing groove 11. The radial sealing groove 11 is arranged axially distanced to an axial contact face of the piston slipper body 3 contacting the ceramic sliding element 7.

The radial sealing element 10 is compressed between the inner circumferential surface of the ceramic sliding ring 7 and a radially inner side of the radial sealing groove 11. This compression causes a frictional resistance against displacement of the ceramic sliding ring 7 with respect to the piston slipper body 3. Especially, the radial sealing element 10 provides a resistance against detaching the ceramic sliding ring 7—and hence the sliding unit 5—from the piston slipper body 3 (along the axial direction). However, if the resistance is overcome by a sufficient axial force, the sliding unit 5 can be detached from the piston slipper body 3.

According to one aspect, the resistance against detaching the sliding unit 5 from the piston slipper body 3 that is provided by the radial sealing element 10 exceeds a gravitational force of the sliding unit 5. For example, said resistance might correspond to at least 1,2 times a weight of the sliding unit.

In other words, the radial sealing element 10 creates a detachable connection between the ceramic sliding element 7 and the piston slipper body 3—and hence between the sliding unit 5 and the piston slipper body 5. On the one hand, the detachable connection facilitates the handling, e.g. during manufacturing and repair of the axial piston machine. On the other hand, the detachable connection facilitates replacing the ceramic sliding element 7.

Additionally, the radial sealing element 10 provides a sealing function.

According to one aspect, the protruding element 8 and the recessed geometry may function as a retaining means, to retain the sliding unit 5 detachably to the piston slipper body 3. To do so, the recessed geometry and/or the protruding element 8 comprise means for a form-fit connection (e.g. a snap-on connection) and/or means to create a friction fit between the compression ring 6 and the piston slipper body 3.

The radial sealing element 10 might also serve as a centering means to center the piston slipper body 3 relative to the sliding unit 5. Alternatively or in addition, the first engagement means (e.g. the protrusions 8) and the second engagement means (e.g. the recesses 9) may also function to center the piston slipper body 3 relative to the sliding unit 5.

The radial sealing element 10 might be annular. It might be an O-ring. It may have a kidney-shaped or archway-shaped cross-section (i.e. the cross section perpendicular to the circumferential direction), wherein a bulge of the kidney-shaped or archway-shaped cross-section of the radial sealing element 10 faces in a direction towards the ceramic sliding element 7 (i.e. radially outwardly).

In FIG. 3, the axial sealing element 12 of the second embodiment is used in combination with the first sealing element 10. In this case, the first sealing element 10 may serve as retaining means to retain the sliding unit 5 to the piston slipper body 3. Alternatively, the second sealing element 12 is the only sealing element used between the piston slipper body 3 and the sliding unit 5. In the alternative case, the sliding unit 5 is detachably retained to the piston slipper body 3 by retaining means provided on the protrusion geometry 8 and/or the recessed geometry, as described above.

The above described embodiments show the compression ring 6 having three protrusions 8 (as the first engagement means). In alternative, not depicted, embodiments the compression ring 6 might have more than three protrusions 8.

The protrusions 8 might be arranged uniformly along the circumferential direction of the compression ring 6 (and hence the circumferential direction about the central axis CA). The recesses 9 might be arranged uniformly along the circumferential direction of the piston slipper body 3 (and hence along the circumferential direction about the central axis CA when the sliding unit 5 is mounted to the piston slipper body 3).

In more general, the first engagement means of the compression ring 6 provide a rotational lock functionality for limiting or preventing rotation of the compression ring 6 and hence also the ceramic sliding element 7/the whole sliding unit 5 with respect to the piston slipper body 3.

For example, the piston slipper body 3 can comprise and/or a first group of protrusions 8 for transmitting rotational load from the ceramic sliding element 7 to the piston slipper body 3 (as the ones shown in the embodiment).

The first engagement means of compression ring 6 might provide additional functionalities.

For example, as already mentioned above, the first engagement means of the compression ring 6 can be configured to provide a centering functionality for centering the compression ring 6 (and hence the ceramic sliding element 7/the sliding unit 5) relative to the piston slipper body 3, for example with respect to the central axis CA. The second engagement means of the piston slipper body 3 can be adapted accordingly. In other words, the first engagement means and the second engagement means can be configured to (e.g. mechanically) interact in order to ensure that the compression ring 6 (and hence the ceramic sliding element 7 fixed therein/the whole sliding unit 5) are mounted coaxially to the piston slipper body 3, especially with regard to the central axis CA. In the shown embodiments, the protrusions 8 and the recesses 9 as shown in the figures, which provide the rotational lock functionality, also ensure proper centering of the compression ring 6 with respect to the piston slipper body 3. In other words, the same elements of the first engagement means (i.e. the protrusions 8) and the same elements of the second engagement means exhibit both the rotational lock functionality and the centering functionality. This is easily possible with at least three protrusions 8 and at least three corresponding recesses 9.

The first engagement means of the compression ring 6 may include separate first centering engagement means, e.g. in form of a second group of protrusions. The second engagement means of the piston slipper body 3 may include corresponding second separate centering engagement means, e.g. in form of a second group of recesses. It is also possible that the rotational lock functionality and the centering functionality are provided by the same elements. For example, the compression ring 6 may comprise a first group of protrusions with at least one protrusion (like the protrusions 8) for providing the rotational lock functionality and a second group of protrusions with at least one protrusions for providing the centering functionality.

Additionally or alternatively, the first engagement means of the compression ring 6 can be configured to provide a retaining functionality for axially retaining the compression ring 6 (and hence the ceramic sliding element 7/the sliding unit 5) relative to the piston slipper body 3 (not shown), optionally detachably. The second engagement means of the piston slipper body 3 can be adapted accordingly. In other words, the first engagement means and the second engagement means can be configured to (e.g. mechanically) interact in order to ensure that the compression ring 6 (and hence the ceramic sliding element 7 fixed therein/the whole sliding unit 5) are axially retained (especially axially fixed) to the piston slipper body 3, especially with regard to the central axis CA. The first engagement means of the compression ring 6 may include separate first retaining engagement means, e.g. in form of a further group of protrusions. The second engagement means of the piston slipper body 3 may include corresponding separate second retaining engagement means, e.g. in form of a further group of recesses. It is also possible that the rotational lock functionality and the retaining functionality are provided by the same elements. Just as a non-limiting example, the firs axial fixation means can include or consist of snap protrusions and the second axial fixation engagement means can include or consist of edges and/or recesses with which the snap protrusions can mechanically engage. In one embodiment, the same protrusions 8 and the same recesses 9 as shown in the figures also ensure proper centering of the compression ring 6 with respect to the piston slipper body 3. Just as an example, the protrusions 8 could additionally be configured to be axially retained in the recesses 9 by additional snap-in noses of the protrusions 8 engaging with corresponding edges and/or sub-recesses in the recesses 9 (not shown).

Of course, it is also possible that the centering functionality and the retaining functionality are provided by the same elements of the first and second engagement means.

The first engagement means (e.g. the protrusions 8) and the second engagement means (e.g. the recesses 9) interact with each other to provide at least one of the following functions:
limiting (or even preventing) a relative rotating movement between the piston slipper body 3 and the sliding unit 5;
centering the sliding unit 5 relative to the piston slipper body 3; and
(e.g. detachably) retaining/fixing the sliding unit 5 to the piston slipper body 3.

Turning back to the embodiments shown in the figures, the main piston slipper body 3B is formed of steel, stainless steel, and/or other steel alloys. The outer and the inner piston slipper body 3A, 3B may be formed of polymers which can comprise fillers. A suitable polymer is, for example, PEEK being filled with fibers, in particular carbon fibers.

In modifications (not shown), in addition or alternative to the protrusions 8 and the recesses 9, matching teeth can be provided at the first axial end face of the compression ring 6 and the adjacent axial end face of the piston slipper body 3. In other words, the first engagement means include axial teeth and the second engagement means includes matching axial teeth.

The combinations of the axial protrusions 8 with the axial recesses 9 as well as the combination of axial teeth have the advantage that a radial size of the sliding unit 5 and the piston slipper 3 can be kept small.

Additionally or alternatively, the compression ring 6 may be splined to the piston slipper body 3 for limiting or even preventing relative rotation of those components. In other words, the first engagement means include spline elements and the second engagement means can include matching spline elements.

It is also possible that the piston slipper body 3 has a detachable sleeve (not shown), wherein both the compression ring 6 and the rest of the piston slipper body 3 are rotationally locked to the sleeve by splines and/or teeth, e.g. radial teeth.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A compression ring for a piston slipper arrangement, wherein the piston slipper arrangement comprises a piston slipper body and a ceramic sliding element and is configured to be provided in an axial piston machine, wherein the compression ring is configured to compress the ceramic sliding element,
wherein the compression ring comprises first engagement means configured for engaging with second engagement means of the piston slipper body in order to limit rotation of the compression ring relative to the piston slipper body.

2. The compression ring according to claim 1, wherein the first engagement means include at least one protruding element.

3. The compression ring according to claim 1, wherein the first engagement means include at least one protrusion, preferably at least three protrusions, protruding in an axial direction of the compression ring.

4. The compression ring according to claim 3, wherein each protrusion comprises at least one contact surface having a normal vector that is parallel to a local circumferential direction of the compression ring.

5. The compression ring according to claim 1, wherein the first engagement means are configured to provide a centering functionality for centering the compression ring relative to the piston slipper body with regard to a central axis (CA) of the compression ring.

6. The compression ring according to claim 1, wherein the first engagement means are configured to provide a retaining functionality for detachably axially retaining the compression ring relative to the piston slipper body.

7. A piston slipper arrangement having a piston slipper body, a compression ring and a ceramic sliding element, wherein the compression ring compresses the ceramic sliding element, wherein the compression ring and the ceramic sliding element form a sliding unit,
wherein the compression ring is formed according to claim 1 and that the piston slipper body comprises the second engagement means.

8. The piston slipper arrangement according to claim 7, wherein the first engagement means comprises at least three protrusions protruding in the axial direction and wherein the second engagement means comprises a corresponding number of recesses.

9. The piston slipper arrangement according to claim 7, wherein the piston slipper arrangement comprises an axial sealing element which seals the piston slipper body against an axial end face of the ceramic sliding element.

10. The piston slipper arrangement according to claim 7, wherein the ceramic sliding element is annular and the piston slipper arrangement comprises a radial sealing element which seals the piston slipper body against an inner circumferential surface of the ceramic sliding element.

11. The piston slipper arrangement according to claim 7, wherein the sliding unit is detachably retained to the piston slipper body.

12. The piston slipper arrangement according to claim 10, wherein radial sealing element serves as means for detachably retaining the sliding unit to the piston slipper body.

13. The piston slipper arrangement according to claim 7, wherein the ceramic sliding element extends in its axial direction beyond the piston slipper body and the compression ring.

14. An axial piston machine comprising a piston slipper arrangement according to claim 7.
